(19) United States
(12) Patent Application Publication
(10) Pub. No.: US 2026/0326694 A1
(43) Pub. Date: Oct. 22, 2026

(54) POWER SUPPLY MANAGEMENT DEVICE

(71) Applicant: TOYOTA JIDOSHA KABUSHIKI KAISHA, Toyota-shi (JP)

(72) Inventor: Masahide OKADA, Nagoya-shi (JP)

(73) Assignee: TOYOTA JIDOSHA KABUSHIKI KAISHA, Toyota-shi (JP)

(21) Appl. No.: 19/531,969

(22) Filed: Feb. 6, 2026

(30) Foreign Application Priority Data
Apr. 18, 2025 (JP) 2025-068712

(51) Int. Cl. B60R 16/033; G06F 1/3206; G06F 1/3287

(52) U.S. Cl. CPC B60R 16/033; G06F 1/3206; G06F 1/3287

(57) ABSTRACT

The controller includes a first storage unit and a second storage unit that store a control program, a third storage unit that can hold the stored contents even when the operation surface is switched, and a processing circuit that executes processing based on the control program of the storage unit of the operation surface among the first storage unit and the second storage unit. The processing includes a storage process of calculating the temperature rise amount for each calculation cycle and storing the integrated value in the third storage unit. The processing circuit updates the control program of the storage unit of the non-operating surface of the first storage unit and the second storage unit, and switches the storage unit in which the control program is updated to the operating surface.

### CROSS-REFERENCE TO RELATED APPLICATION

This application claims priority to Japanese Patent Application No. 2025-068712 filed on Apr. 18, 2025. The disclosure of the above-identified application, including the specification, drawings, and claims, is incorporated by reference herein in its entirety.

### BACKGROUND

### 1. Technical Field

The present disclosure relates to an in-vehicle power supply management device.

### 2. Description of Related Art

Japanese Unexamined Patent Application Publication No. 2024-118749 (JP 2024-118749 A) discloses an in-vehicle electronic control device in which a control program can be updated by OTA. The electronic control device includes a first memory and a second memory that store the control program. For example, when the first memory is set to an operation surface, a process based on the control program in the first memory is executed. When a control program for update is acquired from a server outside a vehicle, the control program in the second memory can be updated even when the process based on the control program in the first memory is being executed. When a predetermined switching condition is met after the completion of the update of the control program in the second memory, a switching process of switching the operation surface from the first memory to the second memory is executed.

### SUMMARY

A case where the electronic control device has a function of calculating an estimated temperature value of a power supply line that connects a battery and an electronic device is considered. The electronic control device executes a countermeasure process of suppressing a temperature rise of the power supply line when the estimated temperature value exceeds a threshold value. In such an electronic control device, there is a possibility that the calculation result of the estimated temperature value is initialized when the control program in the second memory is updated and the switching process is executed, for example. When the calculation result is initialized along with the execution of the switching process in this manner, the execution of the above countermeasure process may be delayed.

In order to address the above issue, a power supply management device is applied to a vehicle including a battery, an electronic device, and a power supply line that connects the battery and the electronic device.

The power supply management device includes: a switching circuit installed in the power supply line; and a controller that performs control so as to turn on and off the switching circuit.
The controller includes a first storage unit and a second storage unit that store a control program, a third storage unit, and a processing circuit that sets one of the first storage unit and the second storage unit to an operation surface and executes a process based on the control program on the operation surface.
The process based on the control program includes
a storage process of estimating a temperature rise amount of the power supply line within a calculation period for each calculation period, and storing an integrated value of the temperature rise amount in the third storage unit, and
a cutoff process of determining whether a cutoff condition for turning off the switching circuit is met based on the integrated value stored in the third storage unit, and turning off the switching circuit when the cutoff condition is met.
   The processing circuit is configured to
update the control program in a storage unit not corresponding to the operation surface, among the first storage unit and the second storage unit, when the process based on the control program corresponding to the operation surface is executed, and
after completion of update of the control program in the storage unit not corresponding to the operation surface, among the first storage unit and the second storage unit, set the storage unit storing the updated control program to the operation surface.
   The third storage unit is configured to hold a stored content even when the operation surface is switched.

It is possible to turn off the switching circuit at an appropriate timing even when the control program in one of the first storage unit and the second storage unit is updated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle including a power supply management device according to an embodiment and OTA servers capable of communicating with the vehicle;

FIG. 2 is a graph illustrating the protection function of the switching circuit of FIG. 1;

FIG. 3 is a flowchart illustrating a series of processes for calculating an integrated value that is one of the information regarding the temperature of the power supply line of FIG. 1;

FIG. 4 is a flowchart illustrating a series of processes for controlling on/off of the switching circuit of FIG. 1; and

FIG. 5 is a sequence diagram illustrating a flow of processing when the control program of the power supply management device of FIG. 1 is updated.

### DETAILED DESCRIPTION OF EMBODIMENTS

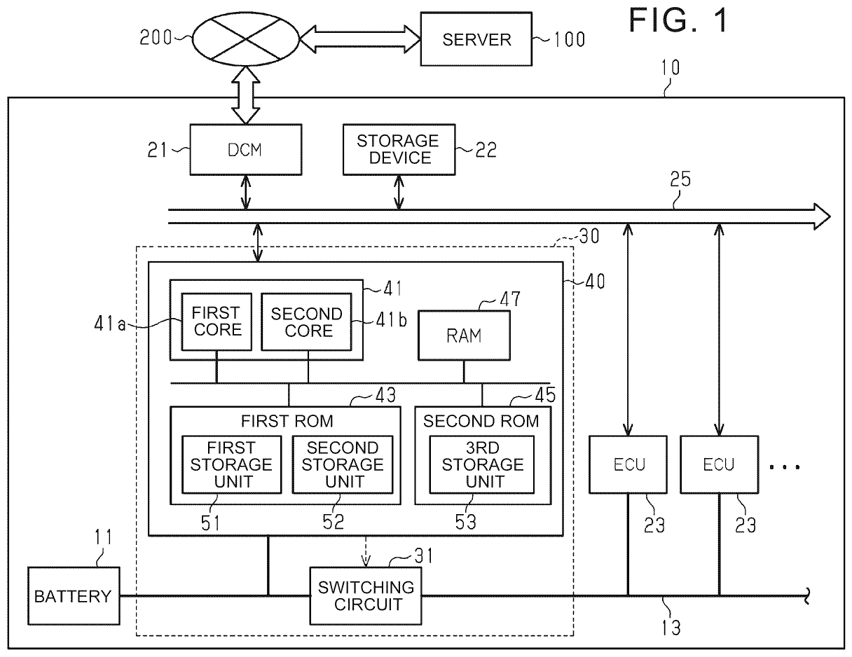

An embodiment of a power supply management device will be described with reference to FIG. 1 to FIG. 5.

FIG. 1 illustrates a vehicle 10 and OTA servers 100 installed outside the vehicle. OTA is an abbreviation for “Over The Air”.

OTA servers 100 manage control programs stored in memories of electronic control units of the vehicles 10. OTA servers 100 transmit and receive various types of data to and from the vehicles 10 via the out-of-vehicle networks 200. The out-of-vehicle network 200 is wireless communication. OTA servers 100 transmit control programs for updating to the vehicles 10.

The vehicle 10 includes a DCM 21 that receives an update control program from OTA servers 100 via the out-of-vehicle network 200, and a storage device 22 that stores the update control program received by DCM 21. “DCM” is an abbreviation for “Data Communication Module”. DCM 21 can access the storage device 22 via the in-vehicle network 25. Therefore, DCM 21 stores the control program for updating received from OTA servers 100 in the storage device 22. An exemplary in-vehicle network 25 is a CAN bus. CAN is an abbreviation for “Controller Area Network”.

The vehicle 10 includes a battery 11, a power supply management device 30, and a plurality of electronic control devices 23. Hereinafter, the electronic control device will be referred to as an “ECU”. ECU 23 is an exemplary “electronic device”. The controllers 40, the plurality of ECU 23, and DCM 21 included in the power supply management device 30 described later are configured to be able to transmit and receive data to and from each other via the in-vehicle network 25. Further, power is supplied from the battery 11 to each of the power supply management device 30 and the plurality of ECU 23 via the power supply line 13.

The power supply management device 30 includes a switching circuit 31 and a controller 40.

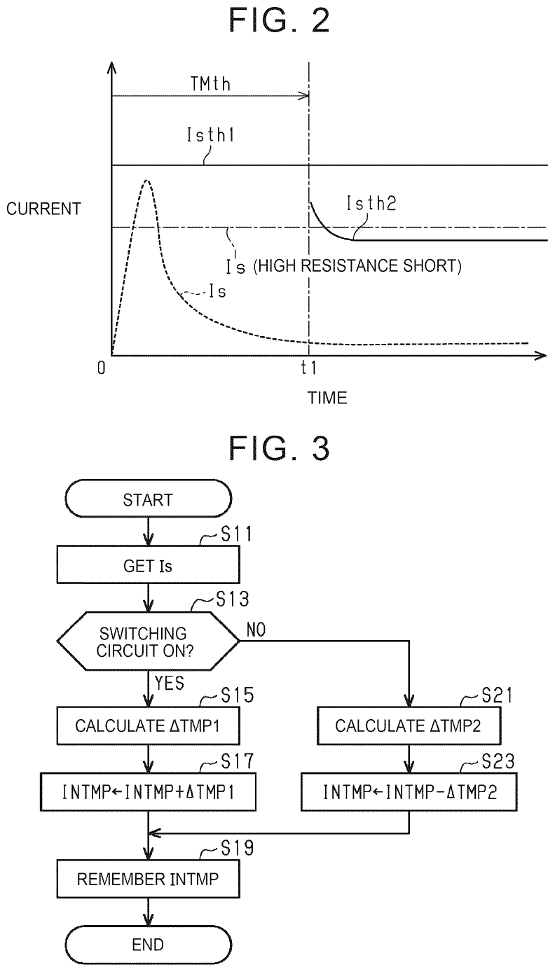

The switching circuit 31 is installed in a power supply line 13 that connects the battery 11 and ECU 23. An example of the switching circuit 31 is a semiconductor fuse. Examples of the semiconductor-fuse include IPD. IPD is an abbreviation for “Intelligent Power Device”. The switching circuit 31 has a self-blocking function. When the switching circuit 31 is on, the value of the current flowing through the switching circuit 31 is referred to as a “line current value Is”. As shown in FIG. 2, the self-cutoff function is, for example, a function of turning off itself when the line current value Is exceeds the first current cutoff-threshold Isth1. A threshold value for suppressing occurrence of dead short-circuit in the switching circuit 31 is set to the first current cutoff threshold value Isth1.

As shown in FIG. 1, the controllers 40 are ECU for controlling on/off of the switching circuit 31. The controllers 40 include a processing circuit 41, a first ROM 43, a second ROM 45, and a RAM 47. An exemplary first ROM 43 and second ROM 45 is a flash memory. The control program is stored in the first ROM 43. The processing circuit 41 executes processing based on the control program of the first ROM 43. The process based on the control program includes a storage process and a blocking process which will be described later. The second ROM 45 includes a third storage unit 53 in which the computation performed by the processing circuit 41 is stored. The second ROM 45 is configured to retain the stored content of the third storage unit 53 even when the control program of the first ROM 43 is updated and the controller 40 is initialized. RAM 47 stores the computation performed by the processing circuit 41 that executes processing based on the control program.

The processing circuit 41 is a multi-core processor having a plurality of cores. The plurality of cores includes a first core 41a and a second core 41b. The first ROM 43 includes a first storage unit 51 and a second storage unit 52. Each of the first storage unit 51 and the second storage unit 52 is a storage area in which a control program is stored. For example, when the first storage unit 51 is set to the operating surface and the second storage unit 52 is set to the non-operating surface, the first core 41a executes a process based on the control program of the first storage unit 51. For example, when the second storage unit 52 is set to the operating surface while the first storage unit 51 is set to the non-operating surface, the second core 41b executes a process based on the control program of the second storage unit 52.

The controllers 40 monitor the line temperature TMP, which is the temperature of the power supply line 13. The controller 40 sets the second current cutoff threshold Isth2 based on the heat generation characteristic of the power supply line 13. The second current cutoff threshold Isth2 is a threshold for suppressing occurrence of a high-resistance short-circuit in the power supply line 13.

Here, when a part of the power supply line 13 is damaged or the like, a high-resistance portion is generated in the power supply line 13. This increases the current flowing through the power supply line 13. As a result, the power supply line 13 may generate heat. Such an event is a high resistance short. The higher the line temperature TMP, the lower the current flowing through the power supply line 13 may be.

A current value that serves as a criterion for determining whether or not a high-resistance short-circuit is likely to occur is referred to as a “boundary current value Isb”. The heat generation property of the power supply line 13 indicates the relation between the line temperature TMP and the boundary current value Isb. According to the heat generation property, the higher the line temperature TMP, the smaller the boundary current value Isb becomes.

The controller 40 derives a boundary current value Isb corresponding to the line temperature TMP at that time based on the heat generation property. Then, the controller 40 sets the derived boundary current value Isb to the second current cutoff threshold Isth2.

FIG. 2 illustrates the transition of the second current cutoff threshold Isth2. The longer the switching circuit 31 is energized, the higher the line temperature TMP. Therefore, when the switching circuit 31 is on, the second current cutoff threshold Isth2 decreases as the period elapses. Then, when it becomes possible to determine that the line temperature TMP is increased to some extent as after the timing t1 shown in FIG. 2, when the line current value Is becomes equal to or larger than the second current cutoff threshold Isth2, the controller 40 turns off the switching circuit 31.

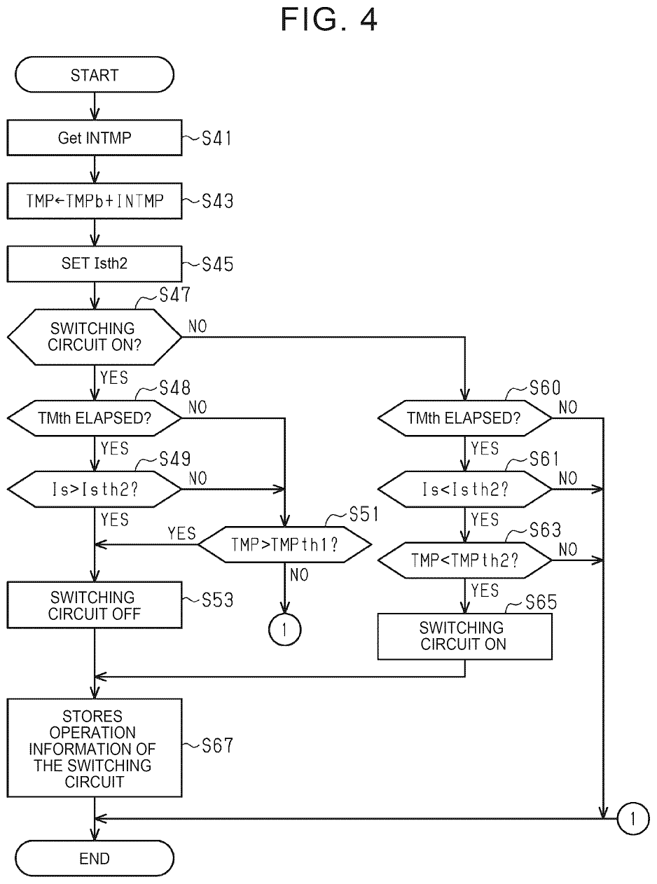

With reference to FIG. 3, the calculation processing of the integrated value executed by the processing circuit 41 of the controller 40 will be described. The processing circuit 41 repeatedly executes the calculation processing for each predetermined calculation cycle. In the present embodiment, the arithmetic processing corresponds to “storage processing”. When the first storage unit 51 is set to the operating surface, the first core 41a executes the calculation process. When the second storage unit 52 is set to the operating surface, the second core 41b executes the calculation process.

In S11, the processing circuit 41 obtains the line current value Is. In the subsequent S13, the processing circuit 41 determines whether the switching circuit 31 is on. For example, when the line current value Is is greater than 0 (zero), the switching circuit 31 is considered to be on. When the line current value Is is 0 (zero), the switching circuit 31 is considered to be off. When the processing circuit 41 determines that the switching circuit 31 is on (S13: YES), the processing circuit 41 shifts the processing to S15. On the other hand, when the processing circuit 41 determines that the switching circuit 31 is off (S13: NO), the processing circuit 41 shifts the processing to S21.

In S15, the processing circuit 41 calculates a temperature increase amount ΔTMP1, which is an increase amount of the line temperature TMP in the calculation cycle. The length of time of the calculation cycle is referred to as “cycle time”. The processing circuit 41 calculates the temperature-rise amount ΔTMP1 so that the value increases as the product of the line current value Is and the cycle time increases.

In the subsequent S17, the processing circuit 41 obtains the integrated value INTMP by integrating the temperature-rise amount ΔTMP1. Specifically, the processing circuit 41 reads the integrated-value INTMP stored in the third storage unit 53. The processing circuit 41 calculates the sum of the temperature-rise amount ΔTMP1 calculated by S15 and the integrated value INTMP as the newest value of the integrated value INTMP. Thereafter, the processing circuit 41 shifts the processing to S19.

In S19, the processing circuit 41 stores the calculated integrated-value INTMP in the third storage unit 53. Then, the processing circuit 41 temporarily ends the arithmetic processing.

In S21, the processing circuit 41 calculates a temperature decrease amount ΔTMP2 which is a decrease amount of the line temperature TMP in the calculation cycle. For example, the processing circuit 41 calculates the temperature decrease amount ΔTMP2 such that the lower the ambient temperature of the power supply management device 30, the larger the value.

In the following S23, the processing circuit 41 updates the integrated-value INTMP based on the calculated temperature-decrease ΔTMP2. Specifically, the processing circuit 41 reads the integrated-value INTMP stored in the third storage unit 53. The processing circuit 41 calculates a value obtained by subtracting the temperature-lowering amount ΔTMP2 from the integrated value INTMP as the most recent value of the integrated value INTMP. At this time, when the value obtained by subtracting the temperature decrease amount ΔTMP2 from the integrated value INTMP is a negative value, the processing circuit 41 sets the integrated value INTMP to 0 (zero). Thereafter, the processing circuit 41 shifts the processing to S19.

The operation processing of the switching circuit 31 executed by the processing circuit 41 of the controller 40 will be described with reference to FIG. 4. The processing circuit 41 executes the operation processing at predetermined execution cycles. The operation processing corresponds to the “interruption processing”. When the first storage unit 51 is set to the operating surface, the first core 41a executes the operating process. When it is set in the second storage unit 52, the second core 41b executes the operating process.

In S41, the processing circuit 41 acquires the integrated-value INTMP from the third storage unit 53. In the subsequent S43, the processing circuit 41 calculates the sum of the temperature base value TMPb and the integrated value INTMP as the line temperature TMP. As a result, the processing circuit 41 can calculate the line temperature TMP such that the larger the integrated value INTMP, the larger the value. An exemplary temperature base value TMPb is the ambient temperature of the switching circuit 31. This line temperature TMP corresponds to the “temperature estimate of the power supply line 13”.

In the following S45, the processing circuit 41 sets the second current cutoff thresholds Isth2 based on the line temperature TMP. At this time, the processing circuit 41 sets the second current cutoff thresholds Isth2 using the heat generation properties of the power supply line 13. As a result, the processing circuit 41 can set a smaller value to the second current cutoff threshold Isth2 as the line temperature TMP increases. At this point, the process of S45 corresponds to the “threshold-setting process”.

In the following S47, the processing circuit 41 determines whether or not the switching circuit 31 is on. When the switching circuit 31 is on (S47: YES), the processing circuit 41 shifts the processing to S48. On the other hand, when the switching circuit 31 is off (S47: NO), the processing circuit 41 shifts the processing to S60.

In S48, the processing circuit 41 determines whether or not the elapsed time from the time when the power supply system of the vehicle 10 is activated has reached the determination time TMth. A criterion for determining whether or not the protection of the switching circuit 31 is better not only for the self-interruption function but also for the software is set to the determination time TMth. For example, an elapsed time, which is a criterion for determining whether or not the line temperature TMP is increased to some extent, is set to the determination time TMth (see FIG. 2). When the elapsed time reaches the determination time TMth (S48: YES), the processing circuit 41 shifts the processing to S49. On the other hand, when the elapsed time has not reached the determination time TMth (S48: NO), the processing circuit 41 shifts the processing to S51.

In S49, the processing circuit 41 determines whether or not the line current value Is is greater than the second current cutoff-threshold Isth2. When the line current value Is is larger than the second current cutoff threshold Isth2 (S49: YES), the processing circuit 41 can determine that the cutoff condition for turning off the switching circuit 31 is satisfied. Therefore, the processing circuit 41 shifts the processing to S53. On the other hand, when the line current value Is is equal to or less than the second current cutoff-threshold Isth2 (S49: NO), the processing circuit 41 shifts the processing to S51.

In S51, the processing circuit 41 determines whether the line temperature TMP is greater than the cutoff determination temperature TMPth1. A line temperature slightly lower than a criterion for determining whether or not the power supply line 13 ignites is set to the cutoff determination temperature TMPth1. When the line temperature TMP is greater than the cutoff determination temperature TMPth1 (S51: YES), the processing circuit 41 can determine that the cutoff condition for turning off the switching circuit 31 is satisfied. Therefore, the processing circuit 41 shifts the processing to S53. On the other hand, when the line temperature TMP is equal to or lower than the cutoff determination temperature TMPth1 (S51: NO), the processing circuit 41 can determine that the cutoff condition is not satisfied. Therefore, the processing circuit 41 temporarily ends the operation processing.

In S53, the processing circuit 41 turns off the switching circuit 31. Then, the processing circuit 41 shifts the processing to S67.

In S60, the processing circuit 41 determines whether or not the elapsed time from the time when the power supply system of the vehicle 10 is activated has reached the determination time TMth. When the elapsed time reaches the determination time TMth (S60: YES), the processing circuit 41 shifts the processing to S61. On the other hand, when the above-described elapsed time does not reach the determination time TMth (S60: NO), the processing circuit 41 temporarily ends the operating processing.

In S61, the processing circuit 41 determines whether or not the line current value Is is smaller than the second current cutoff-threshold Isth2. When the line current value Is is smaller than the second current cutoff threshold Isth2 (S61: YES), the processing circuit 41 shifts the processing to S63. On the other hand, when the line current value Is is equal to or larger than the second current cutoff-threshold Isth2 (S61: NO), the processing circuit 41 temporarily ends the operating processing.

In S63, the processing circuit 41 determines whether the line temperature TMP is lower than the connection-determination temperature TMPth2. The connection determination temperature TMPth2 is set to be smaller than the cutoff determination temperature TMPth1. When the line temperature TMP is smaller than the connection-determination temperature TMPth2 (S63: YES), the processing circuit 41 shifts the processing to S65. On the other hand, when the line temperature TMP is equal to or higher than the connection determination temperature TMPth2 (S63: NO), the processing circuit 41 temporarily ends the operating processing.

In S65, the processing circuit 41 turns on the switching circuit 31. Then, the processing circuit 41 shifts the processing to S67.

In S67, the processing circuit 41 stores operational information, which is information about the switching circuit 31 at the present time, in the third storage unit 53. For example, when the processing circuit 41 turns off the switching circuit 31 in S53, the processing circuit 41 stores the manipulation data indicating that the switching circuit 31 is off in the third storage unit 53. In addition, for example, when the processing circuit 41 turns on the switching circuit 31 in S65, the processing circuit 41 stores the manipulation data indicating that the switching circuit 31 is on in the third storage unit 53. After that, the processing circuit 41 temporarily ends the operation processing.

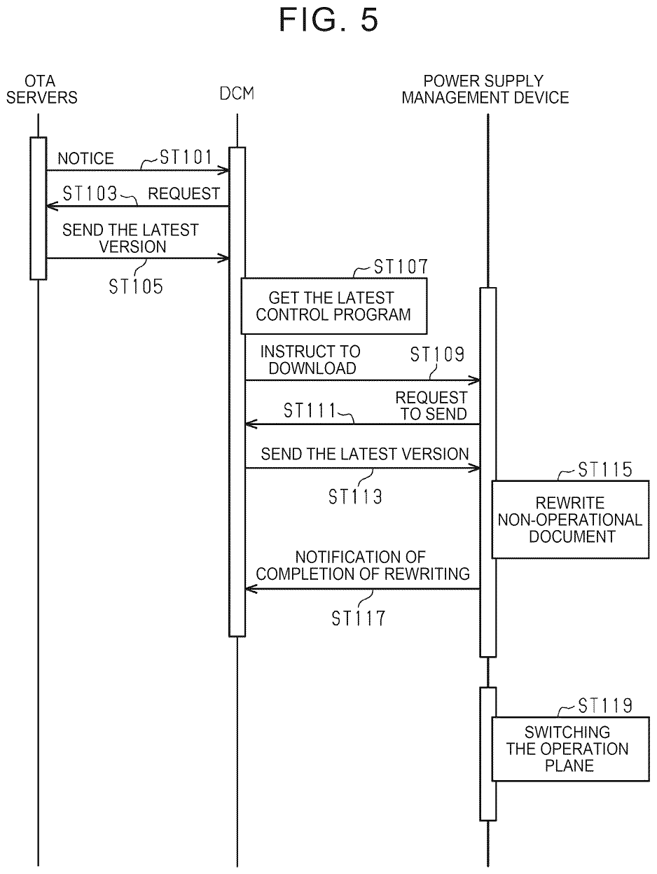

With reference to FIG. 5, a flow of processing when the control program is updated will be described. For example, a case will be described where the control program of the second storage unit 52 is updated in a situation where the first storage unit 51 is set to the operating surface and the first core 41a is executing a process based on the control program of the first storage unit 51.

When OTA server 100 can prepare the latest control program, OTA server 100 notifies the vehicle 10 that the control program of the power supply management device 30 can be updated in ST101.

When DCM 21 receives the notification, in ST103, DCM 21 requests OTA servers 100 to send the most recent control program.

When OTA server 100 receives the above-described request, OTA server 100 transmits the latest control program as the control program for updating to the vehicles 10 in ST105.

In ST107, DCM 21 acquires the received most recent control program and stores the control program in the storage device 22. In a subsequent ST109, DCM 21 instructs the controllers 40 of the power supply management device 30 to download the most recent control program.

When the processing circuit 41 of the controller 40 receives the above instruction, in ST111, the processing circuit 41 requests DCM 21 to transmit the most recent control program to the controller 40.

When DCM 21 receives the request, in ST113, DCM 21 transmits the most recent control program stored in the storage device 22 to the controllers 40 as a control program for updating.

Then, in ST115, the processing circuit 41 downloads the latest control program and stores the control program in the second storage unit 52 which is a non-operating surface. Thus, the processing circuit 41 can rewrite the control program of the second storage unit 52. When rewriting of the control program of the second storage unit 52 is completed, in ST117, the processing circuit 41 contacts DCM 21 to complete rewriting of the control program.

After that, when the permission condition for switching the operating surface is satisfied, the processing circuit 41 executes a switching processing for switching the operating surface in ST119. The permission condition includes, for example, that the vehicle 10 is parked. The processing circuit 41 sets the second storage unit 52 in which the control program has been updated as the operating surface, while setting the first storage unit 51 as the non-operating surface. At this time, the processing circuit 41 initializes the controller 40. Thus, the processing circuit 41 can execute the processing based on the control program of the second storage unit 52, that is, the latest control program.

The first update procedure, which is a flow of processing when the control program of the second storage unit 52 is updated, has been described above. The second update procedure, which is a flow of processing when the control program of the first storage unit 51 is updated, is equivalent to the first update procedure. Therefore, the description of the second update procedure is omitted.

The action and effect of the present embodiment will be described.
(1) In the storage process, the processing circuit 41 stores the integrated-value INTMP in the third storage unit 53. The third storage unit 53 is configured to hold stored contents even when the switching process is executed. Therefore, even when the switching process is executed, the integrated-value INTMP is not reset. As a consequence, the processing circuit 41 can calculate the line temperature TMP in consideration of the temperature increase until the switching processing is executed. Therefore, even when the control program of one of the first storage unit 51 and the second storage unit 52 is updated by OTA, the processing circuit 41 can turn off the switching circuit 31 at an appropriate timing.
(2) The processing circuit 41 also stores the operation information of the switching circuit 31 in the third storage unit 53. Therefore, the processing circuit 41 can immediately grasp whether the switching circuit 31 is on or off immediately after the switching process is completed.
(3) Even when the line current value Is is less than the first current cutoff threshold Isth1, a high-resistance short-circuit may occur in the power supply line 13. Further, the higher the power supply line 13, the lower the line current value Is and the higher the resistivity. Therefore, the processing circuit 41 sets the second current cutoff thresholds Isth2 such that the integrated value INTMP, i.e., the larger the line temperature TMP, the smaller the value. Then, the processing circuit 41 turns off the switching circuit 31 when the line current value Is becomes larger than the second current interruption threshold Isth2 in the interruption processing. Accordingly, the processing circuit 41 can suppress occurrence of a high-resistance short circuit.
(4) The processing circuit 41 calculates the line temperature TMP based on the integrated-value INTMP. When the line temperature TMP becomes larger than the cutoff determination temperature TMPth1, the processing circuit 41 turns off the switching circuit 31. Accordingly, the processing circuit 41 can appropriately protect the power supply line 13 and the switching circuit 31.

The above-described embodiment can be modified as follows. The above-described embodiments and the following modifications can be implemented in combination with each other as long as they are not technically contradictory.
When the switching process is executed, the calculation of the temperature increase amount ΔTMP1 is stopped. Therefore, after the switching process is completed, the processing circuit 41 may perform estimation calculation of the temperature rise amount during the switching process. In this case, it is preferable that the processing circuit 41 calculates the temperature-rise amount during the switching process so that the value increases as the product of the time required for the switching process and the line current value Is at the beginning of the switching process increases. Then, the processing circuit 41 may update the integrated value INTMP by adding the temperature-rise amount to the integrated value INTMP.
The switching circuit 31 may not have a self-blocking function. Even in this case, the processing circuit 41 can protect the switching circuit 31 by software processing.
The processing circuit 41 may not store the operation information of the switching circuit 31 in the third storage unit 53.
In the operation processing described with reference to FIG. 4, the processing circuit 41 may temporarily terminate the operation processing when the determination of S48 is negative.
Processing circuit 41, when it is determined whether to turn off the switching circuit 31 by a comparison between the line current value Is and the second current cutoff threshold Isth2, the switching circuit 31 by a comparison between the line temperature TMP and the cutoff determination temperature TMPth1 it is not necessary to execute a process of determining whether to turn off.
When the processing circuit 41 determines whether or not to turn off the switching circuit 31 by comparing the line temperature TMP with the cutoff determination temperature TMPth1, it is not necessary to execute the processing of determining whether or not to turn off the switching circuit 31 by comparing the line current value Is with the second current cutoff threshold Isth2.
In the above-described embodiment, the first storage area functions as the first storage unit 51 and the second storage area functions as the second storage unit 52 in the first ROM 43, but the present disclosure is not limited thereto. For example, the controller 40 may be configured to separately include a memory functioning as the first storage unit 51 and a memory functioning as the second storage unit 52.
The memory including the third storage unit 53 may be a volatile memory or a non-volatile memory as long as the stored contents can be held even when the switching process is executed.
The electronic device to which electric power is supplied from the battery 11 via the power supply line 13 may include a device other than ECU. For example, the electronic device may be an actuator such as a motor.
The controllers 40 include a CPU and a ROM, and are not limited to those that execute software-processing. That is, the controller 40 may have any of the following configurations (a), (b), and (c).
(a) The controller 40 includes one or more processors that execute various kinds of processing in accordance with a computer program. The processor includes CPU and memories such as RAM and ROM. The memory stores a program code or an instruction configured to execute the CPU to perform processes. Memory, or computer readable media, includes any available media that can be accessed by a general purpose or special purpose computer.
(b) The controller 40 includes one or more dedicated hardware circuits for executing various processes. Dedicated hardware circuits may include, for example, application-specific integrated circuits, i.e., ASIC or FPGA. Note that ASIC is an abbreviation of “Application Specific Integrated Circuit”, and FPGA is an abbreviation of “Field Programmable Gate Array”.
(c) The controller 40 includes one or more processors that execute a part of various kinds of processing in accordance with a computer program, and one or more hardware circuits dedicated to executing the remaining processing among the various kinds of processing.

What is claimed is:

1. A power supply management device to be applied to a vehicle including a battery, an electronic device, and a power supply line that connects the battery and the electronic device, the power supply management device comprising
a switching circuit installed in the power supply line; and a controller that performs control so as to turn on and off the switching circuit, wherein:
the controller includes a first storage unit and a second storage unit that store a control program, a third storage unit, and a processing circuit that sets one of the first storage unit and the second storage unit to an operation surface and executes a process based on the control program on the operation surface;
the process based on the control program includes
a storage process of estimating a temperature rise amount of the power supply line within a calculation period for each calculation period, and storing an integrated value of the temperature rise amount in the third storage unit, and
a cutoff process of determining whether a cutoff condition for turning off the switching circuit is met based on the integrated value stored in the third storage unit, and turning off the switching circuit when the cutoff condition is met;
the processing circuit is configured to
update the control program in a storage unit not corresponding to the operation surface, among the first storage unit and the second storage unit, when the process based on the control program corresponding to the operation surface is executed, and
after completion of update of the control program in the storage unit not corresponding to the operation surface, among the first storage unit and the second storage unit, set the storage unit storing the updated control program to the operation surface; and
the third storage unit is configured to hold a stored content even when the operation surface is switched.

2. The power supply management device according to claim 1, wherein:
the switching circuit has a self-cutoff function of turning off the switching circuit itself when a current value of a current flowing through the switching circuit itself exceeds a current cutoff threshold value; and
the processing circuit stores operation information regarding whether the switching circuit has been turned off in the third storage unit.

3. The power supply management device according to claim 2, wherein:
the current cutoff threshold value is a first current cutoff threshold value; and
the processing circuit is configured to
set a second current cutoff threshold value so as to become smaller as the integrated value stored in the third storage unit is larger, and
turn off the switching circuit when the current value exceeds the second current cutoff threshold value in the cutoff process.

4. The power supply management device according to claim 1, wherein in the cutoff process, the processing circuit calculates an estimated temperature value of the power supply line so as to become larger as the integrated value stored in the third storage unit is larger, and determines that the cutoff condition is met when the estimated temperature value is larger than a cutoff determination temperature.
